(19) United States
(12) Patent Application Publication
(10) Pub. No.: US 2013/0109423 A1
(43) Pub. Date: May 2, 2013

(54) MOBILE COMMUNICATION METHOD, MOBILE STATION, AND RADIO BASE STATION

(71) Applicants: Mikio Iwamura, Chiyoda-ku (JP); Wuri Andarmawanti Hapsari, Chiyoda-ku (JP); Anil Umesh, Chiyoda-ku (JP)

(72) Inventors: Mikio Iwamura, Chiyoda-ku (JP); Wuri Andarmawanti Hapsari, Chiyoda-ku (JP); Anil Umesh, Chiyoda-ku (JP)

(73) Assignee: NTT DOCOMO, INC., Tokyo (JP)

(21) Appl. No.: 13/261,491

(22) PCT Filed: Apr. 28, 2011
(86) PCT No.: PCT/JP2011/060418

§ 371 Date: Jan. 10, 2013

(30) Foreign Application Priority Data
Apr. 30, 2010 (JP) 2010-106006

(51) Int. Cl. H04W 72/10; H04W 24/00

(52) U.S. Cl. CPC H04W 72/10; H04W 24/00
USPC 455/512

(57) ABSTRACT

A mobile communication method according to the present invention includes a step A of transmitting to the radio base station eNB, by a radio base station eNB, “MDT MeasConfig” in which “MeasObject” and “ReportConfig” are included, to a mobile station UE, and a step B of transmitting, by the mobile station UE, by using SRB designated by the “ReportConfig”, “MDT MeasReport” in which a measurement result in a measurement target designated by the “MeasObject” is included.

### TECHNICAL FIELD

The present invention relates to a mobile communication method, a mobile station, and a radio base station.

### BACKGROUND ART

At the present time, in 3GPP, “MDT (Minimization of Drive Tests)” is discussed. According to the MDT, a network collects measurement results of a radio quality from a mobile station UE, thereby minimizing the necessity of radio wave measurement conventionally performed by an operator.

Furthermore, the MDT includes “Logged MDT” and “Immediate MDT”.

In the “Logged MDT”, when the measurement results of a radio quality are stored as logs and a predetermined amount of logs are collected, the mobile station UE is configured to collectively report the logs to the network.

In the “Immediate MDT”, the mobile station UE is configured to immediately report the measurement results of a radio quality to the network whenever a trigger is generated.

As a trigger of the “Immediate MDT”, for example, an event trigger called “Serving<thresh (corresponding to Event-A2)”, “Periodical” serving as a periodical trigger, “detection of RLF (Radio Link Failure)”, and the like are considered.

As the “Immediate MDT”, basically, diverting “MeasConfig” or “MeasReport” of a conventional LTE (Long Term Evolution) Release-8/9 scheme is considered.

Furthermore, the “MeasConfig” or the “MeasReport” of the LTE Release-8/9 scheme is basically designed to perform a measurement process and a measurement report of a serving cell or a neighboring cell for the purpose of a mobility support.

The “MeasConfig” is used to perform setting for a measurement process to be performed by the mobile station UE for the mobility support, or transmission of the “MeasReport”. The “MeasConfig” may include one or a plurality of “ReportConfig”, “MeasObject”, or “MeasId”.

The “ReportConfig” is used to set a condition to transmit the “MeasReport” from the mobile station UE to a radio base station eNB.

For example, according to a condition defined in Event A3, when a measurement result of a radio quality of a neighboring cell is improved by an offset value or more than a measurement result of a radio quality of a current serving cell, the “MeasReport” is transmitted.

Furthermore, according to a condition defined in Event A4, when a measurement result of a radio quality of a neighboring cell is more than a predetermined threshold value, the “MeasReport” is transmitted.

Furthermore, according to a condition defined in Event A2, when a measurement result of a radio quality of a current serving cell is equal to or less than a predetermined threshold value, the “MeasReport” is transmitted.

Furthermore, according to a condition defined in the “Periodical”, a measurement result of a radio quality of a serving cell or a neighboring cell is reported by the “MeasReport” with a predetermined reporting periodicity.

The offset value, the predetermined threshold value, the predetermined reporting periodicity, the number of reports, the type of the condition and the like are set by the “ReportConfig”.

Meanwhile, the “MeasObject” is used to set RAT (Radio Access Technology) or a frequency to be measured by the mobile station. The “MeasObject” includes an offset value to be applied to a measurement result of each cell, a list of cells that should be excluded from a measurement target, and the like.

The “MeasId” is used to link single “ReportConfig” to single “MeasObject”, and the mobile station UE measures only a measurement target designated by the “MeasObject” to which the “MeasId” has been linked, and transmits to the radio base station eNB

“MeasReport” including a measurement result only when a condition designated by the “ReportConfig” linked to the “MeasObject” is satisfied by the “MeasId.

FIG. 6 shows a relation among the “ReportConfig”, the “MeasObject”, and the “MeasId”.

In the LTE Release-8/9 scheme, all C-plane signaling or U-plane data is transmitted through a radio bearer.

As a radio bearer for the C-plane signaling, two SRBs (Signalling Radio Bearer), that is, SRB1 and SRB2 are set.

The SRB1 is used for transmission of RRC (Radio Resource Control) signaling, and some NAS (Non Access Stratum) message transmitted after being connected to an RRC message at the time of initial connection, and the SRB2 is used for transmission of remaining all NAS signaling.

Furthermore, by using DRB (Data Radio Beare: radio bearer for data) set in each QoS, the U-plane data is transmitted.

The priority of the SRB1 is set to be the highest, and the priority of the SRB2 is set to be the next highest. Furthermore, the priority of the DRB is determined according to QoS, exactly, QCI (QoS Class Indicator) notified from a mobile management node MME at the time of setting of a radio bearer.

### CITATION LIST

### Patent Literature

[PTL 1] Japanese Patent Application Laid-Open No. 2008-199223 (Japanese Patent Application No. 2007-031334)

Furthermore, the applicant found the following problems in the aforementioned mobile communication system.

In the mobile communication system, when performing the MDT, particularly, the “Immediate MDT”, the number of transmissions of the “MeasReport” is increased, and thus there is a problem that the consumption amount of a radio resource or a network load is increased.

In the LTE Release-8/9 scheme, the “MeasReport” is defined to be transmitted through the SRB1.

However, basically, the MDT is performed when the network side collects a radio quality, and originally has a priority lower than the C-plane signaling transmitted through the SRB1/SRB2. Moreover, there is no problem even through the MDT has a priority lower than almost all U-plane data.

Thus, when “MDT MeasReport” is transmitted through the SRB1, the efficiency is low. Particularly, when the “MDT MeasReport” is frequently transmitted, a radio resource is preferentially consumed, and thus there is a problem that the transmission efficiency or capacity of the U-plane data is reduced.

In this regard, Patent Literature 1 proposes that SRB3 should be newly defined for the MDT.

However, Patent Literature 1 does not disclose a detailed method of setting or using the SRB3.

Furthermore, the SRB1 and the SRB2 are defined to be set up at the time of initial connection. However, the SRB3 is not necessary in normal communication, and thus is set up only when the MDT is performed.

However, Patent Literature 1 does not disclose a timing of setting the SRB3, or a method thereof.

Therefore, the present invention has been achieved in view of the above-described problems, and an object thereof is to provide a mobile communication method, a mobile station, and a radio base station, by which it is possible to perform MDT without wasting a radio resource in SRB1 and SRB2.

### SUMMARY OF THE INVENTION

A first characteristic of the present embodiment is summarized in that a mobile communication method includes: a step A of transmitting to a mobile station, by a radio base station, test-use measurement control information in which measurement target information and a reporting condition are included; and a step B of transmitting to the radio base station, by the mobile station, by using a signaling-use radio bearer designated by the reporting condition, a test-use measurement report in which a measurement result in a measurement target is included designated by the measurement target information.

A second characteristic of the present embodiment is summarized in that a mobile station includes: a reception unit configured to receive from a radio base station test-use measurement control information in which measurement target information and a reporting condition are included; and a transmission unit configured to transmit to the radio base station, by using a signaling-use radio bearer designated by the reporting condition, a test-use measurement report in which a measurement result in a measurement target is included designated by the measurement target information.

A third characteristic of the present embodiment is summarized in that a radio base station includes: a transmission unit configured to transmit to a mobile station test-use measurement control information in which measurement target information and a reporting condition are included; and a reception unit configured to receive from the mobile station, by using a signaling-use radio bearer designated by the reporting condition, a test-use measurement report in which a measurement result in a measurement target designated by the measurement target information is included.

As described above, according to the present invention, it is possible to provide a mobile communication method, a mobile station, and a radio base station, by which it is possible to perform MDT without wasting a radio resource in SRB1 and SRB2.

### BRIEF DESCRIPTION OF DRAWINGS

FIG. 1 is a diagram showing the entire configuration of a mobile communication system according to a first embodiment of the present invention.

FIG. 2 is a functional block diagram of a radio base station according to the first embodiment of the present invention.

FIG. 3 is a diagram illustrating an example of a format of “ReportConfig” transmitted by the radio base station according to the first embodiment of the present invention.

FIG. 4 is a functional block diagram of a mobile station according to the first embodiment of the present invention.

FIG. 5 is a sequence diagram illustrating an operation of the mobile communication system according to the first embodiment of the present invention.

FIG. 6 is a diagram for explaining a measurement process in a conventional mobile communication system.

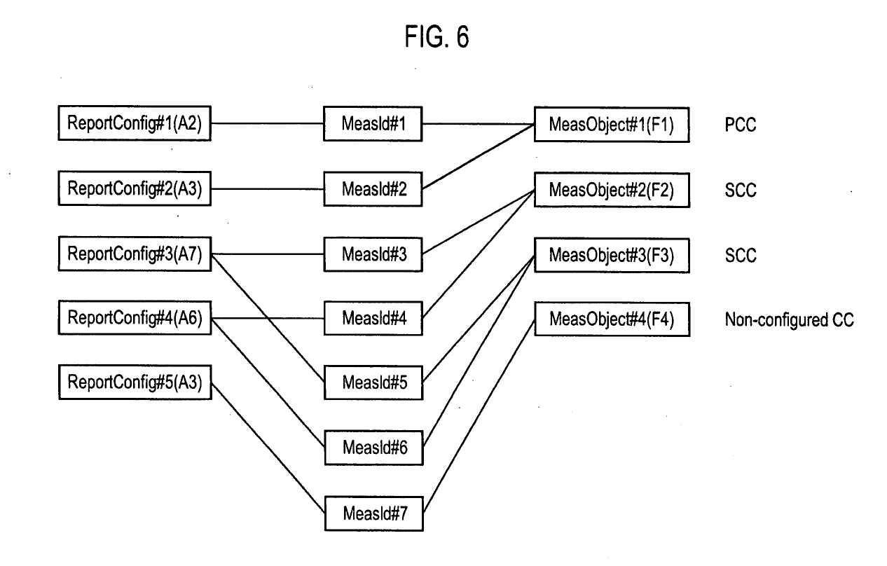

### DESCRIPTION OF EMBODIMENTS

(Mobile Communication System According to First Embodiment of the Present Invention)

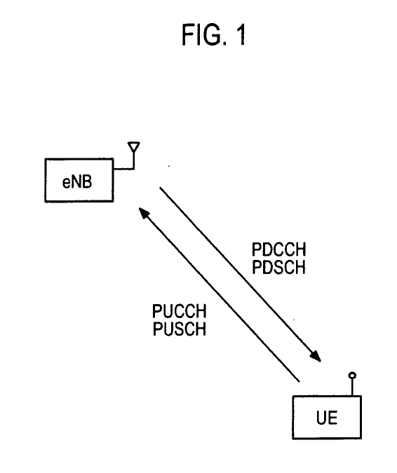

With reference to FIG. 1 to FIG. 5, the configuration of a mobile communication system according to a first embodiment of the present invention will be described.

As illustrated in FIG. 1, in the mobile communication system according to the present embodiment, a mobile station UE is configured to transmit an uplink data signal through PUSCH (Physical Uplink Shared Channel, an uplink shared channel), and to transmit an uplink control signal through PUCCH (Physical Uplink Control Channel, an uplink control channel).

Furthermore, in the mobile communication system according to the present embodiment, a radio base station eNB is configured to transmit a downlink data signal through PDSCH (Physical Downlink Shared Channel, a downlink shared channel), and to transmit a downlink control signal through PDCCH (Physical Downlink Control Channel, a downlink control channel).

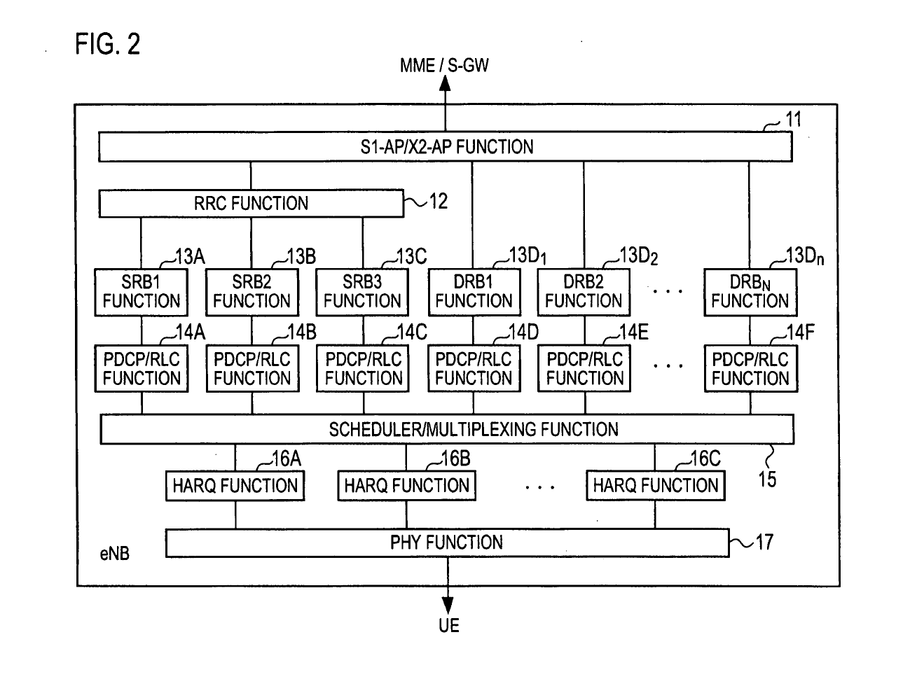

As illustrated in FIG. 2, the radio base station eNB includes, for each mobile station UE, an S1-AP/X2-AP function 11, an RRC function 12, a SRB1 function 13A, a SRB2 function 13B, a SRB3 function 13C, a DRB1 function 13D1 to a DRBn function 13Dn, PDCP/RLC functions 14A to 14F, a Scheduler/Multiplexing function 15, HARQ functions 16A to 16C, and a PHY function 17.

The S1-AP/X2-AP function 11 is configured to perform a process in an S1-AP/X2-AP layer, and the RRC function 12 is configured to perform a process in an RRC layer.

Furthermore, the SRB1 function 13A is configured to perform a process related to SRB1, the SRB2 function 13B is configured to perform a process related to SRB2, the SRB3 function 13C is configured to perform a process related to SRB3, and the DRB1 function 13D1 to the DRBn function 13Dn are configured to perform a process related to DRB1 to DRB3.

The PDCP (Packet Data Convergence Protocol)/RLC (Radio Link Control) functions 14A to 14F are configured to perform a process in a PDCP/RLC layer.

The Scheduler/Multiplexing function 15 is configured to perform a scheduling process and a multiplexing process, the HARQ functions 16A to 16C are configured to perform a retransmission control process based on HARQ, and the PHY function 17 is configured to perform a process in a physical layer.

Furthermore, the SRB1 function 13A is configured to transmit, by using the SRB1, “MeasConfig” in which “MeasObject” and “ReportConfig” are included.

On the other hand, the SRB3 function 13C is configured to transmit, by using the SRB3, “MDT MeasConfig” including the “MeasObject” and the “ReportConfig”.

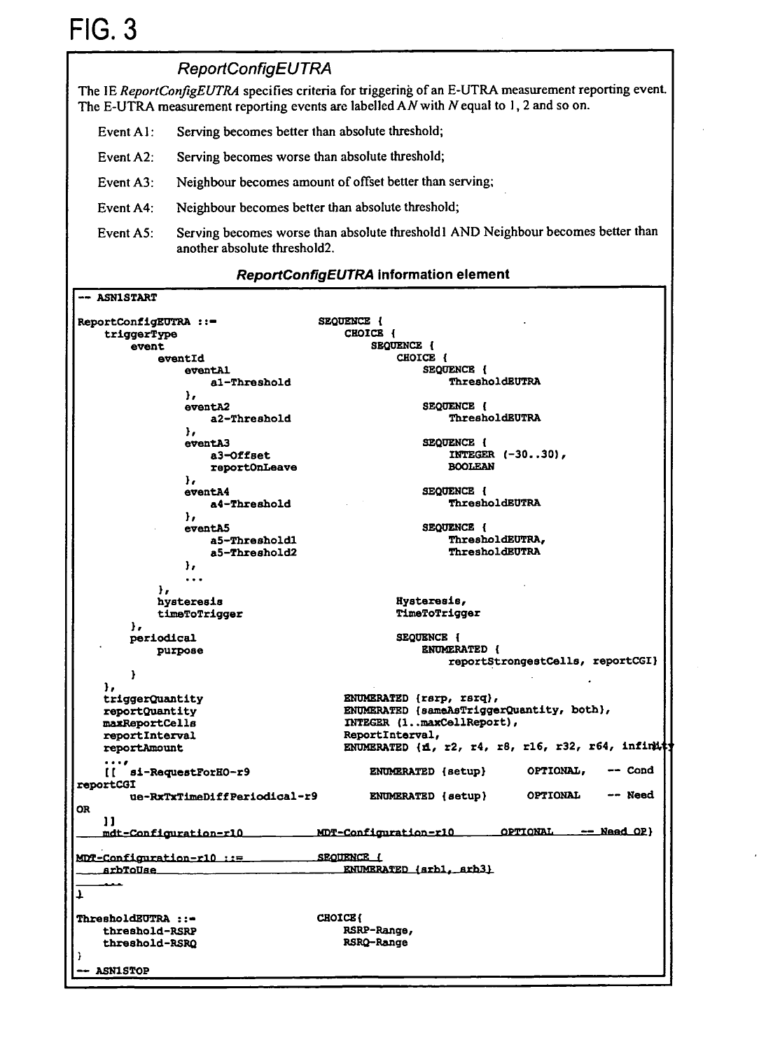

For example, as illustrated in FIG. 3, it is possible for the SRB3 function 13C to set “srb3” in “srbToUse” in an information element “mdt-Configuration-r10” in the “ReportConfig” included in the “MDT MeasConfig”, and thus to instruct the radio base station eNB to transmit, by using the SRB3, “MDT MeasReport” to the mobile station UE.

Alternatively, the SRB3 function 13C may newly define and use another information element in the “ReportConfig”, for example, an “event trigger” for MDT, and thus instruct the radio base station eNB to transmit, by using the SRB3, the “MDT MeasReport” to the mobile station UE.

In addition, the SRB1 function 13A may be configured to transmit, by using the SRB1, the “MDT MeasConfig” including the “MeasObject” and the “ReportConfig”.

Furthermore, the SRB1 function 13A may be configured to receive, by using the SRB1 designated by the “ReportConfig”, “MeasReport” in which a measurement result in a measurement target designated by the “MeasObject” is included, from the mobile station UE.

On the other hand, the SRB3 function 13C is configured to receive from the mobile station UE, by using the SRB3 designated by the “ReportConfig”, the “MDT MeasReport” in which the measurement result in the measurement target designated by the “MeasObject” is included.

In addition, the SRB1 function 13A may be configured to receive, by using the SRB1 designated by the “ReportConfig”, the “MDT MeasReport” in which the measurement result in the measurement target designated by the “MeasObject” is included, from the mobile station UE.

Furthermore, the SRB1 function 13A is configured to set up, by using the SRB1, the SRB3 between the radio base station eNB and the mobile station UE.

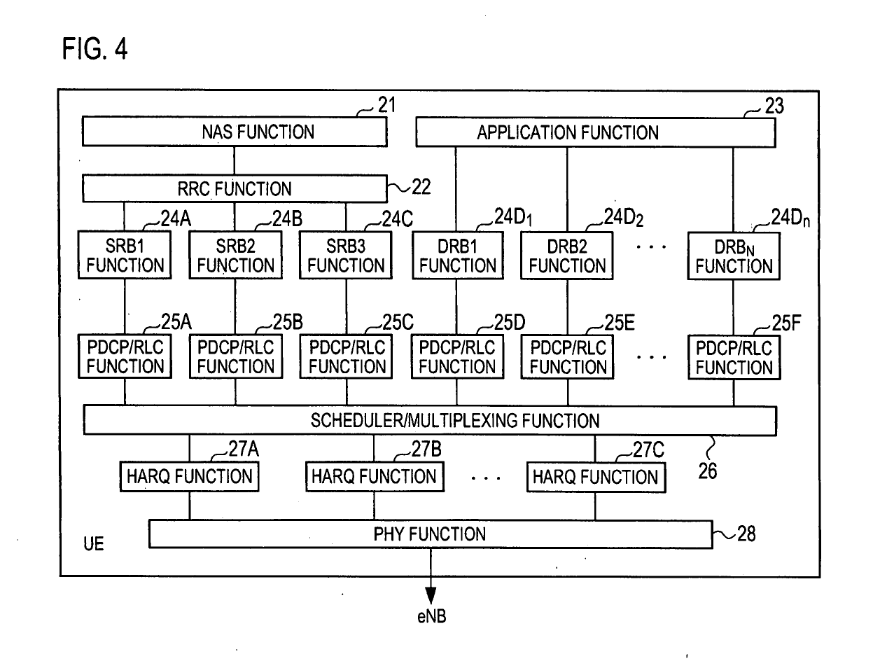

As illustrated in FIG. 4, the mobile station UE includes a NAS function 21, an RRC function 22, an Application function 23, a SRB1 function 24A, a SRB2 function 24B, a SRB3 function 24C, a DRB1 function 24D1 to a DRBn function 24Dn, PDCP/RLC functions 25A to 25F, a Scheduler/Multiplexing function 26, HARQ functions 27A to 27C, and a PHY function 28.

The NAS function 21 is configured to perform a process in a NAS layer, the RRC function 22 is configured to perform a process in an RRC layer, and the Application function 23 is configured to perform a process of in an Application layer.

Furthermore, the SRB1 function 24A is configured to perform a process related to SRB1, the SRB2 function 24B is configured to perform a process related to SRB2, the SRB3 function 24C is configured to perform a process related to SRB3, and the DRB1 function 24D1 to the DRBn function 24Dn are configured to perform a process related to DRB1 to DRB3.

The PDCP/RLC functions 25A to 25F are configured to perform a process in a PDCP/RLC layer, the Scheduler/Multiplexing function 26 is configured to perform a scheduling process and a multiplexing process, the HARQ functions 27A to 27C are configured to perform a retransmission control process based on HARQ, and the PHY function 28 is configured to perform a process in a physical layer.

Furthermore, the SRB1 function 24A is configured to receive, by using the SRB1, the “MeasConfig” including the “MeasObject” and the “ReportConfig”.

On the other hand, the SRB3 function 24C is configured to receive, by using the SRB3, the “MDT MeasConfig” including the “MeasObject” and the “ReportConfig”.

In addition, the SRB1 function 24A may be configured to receive, by using the SRB1, the “MDT MeasConfig” including the “MeasObject” and the “ReportConfig”.

Furthermore, the SRB1 function 24A is configured to transmit to the radio base station eNB, by using the SRB1 designated by the “ReportConfig”, the “MeasReport” in which the measurement result in the measurement target designated by the “MeasObject” is included.

On the other hand, the SRB3 function 24C is configured to transmit to the radio base station eNB, by using the SRB3 designated by the “ReportConfig”, the “MDT MeasReport” in which the measurement result in the measurement target designated by the “MeasObject” is included.

For example, as illustrated in FIG. 3, when the “srb3” is set in the “srbToUse” in the information element “mdt-Configuration-r10” in the “ReportConfig” included in the “MDT MeasConfig”, the SRB3 function 24C is configured to transmit the “MDT MeasReport”, by using the SRB3.

Alternatively, when another information element in the “ReportConfig”, for example, an “event trigger” for MDT is set, the SRB3 function 24C may be configured to transmit the “MDT MeasReport”, by using the SRB3.

In addition, the SRB1 function 24A may be configured to transmit to the radio base station eNB, by using the SRB1 designated by the “ReportConfig”, the “MDT MeasReport” in which the measurement result in the measurement target designated by the “MeasObject” is included.

Furthermore, the SRB1 function 24A is configured to set up, by using the SRB1, the SRB3 between the mobile station UE and the radio base station eNB.

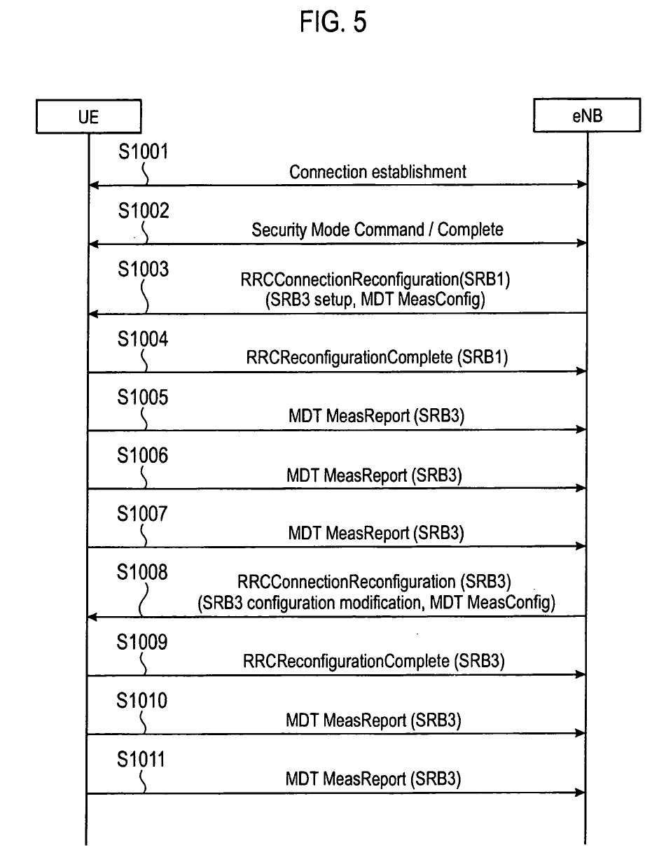

With reference to FIG. 5, the operation of the mobile communication system according to the present embodiment will be explained, below.

As illustrated in FIG. 5, an RRC connection is set up between the radio base station eNB and the mobile station UE in step S1001, and a SMC (Security Mode Command/Complete) process is performed between the radio base station eNB and the mobile station UE in step S1002.

Furthermore, between the radio base station eNB and the mobile station UE, the SRB1 and the SRB2 are set up.

In step S1003, the radio base station eNB transmits to the mobile station UE “RRCConnectionReconfiguration (MDT MeasConfig)”, which instructs to set up, by using the SRB1, the SRB3 between the radio base station eNB and the mobile station UE.

In step S1004, the mobile station UE transmits to the radio base station eNB, by using the SRB1, “RRCConnectionReconfigurationComplete”.

In steps S1005 to S1007, when a condition designated by the “ReportConfig” is satisfied, the mobile station UE transmits, by using the SRB3 designated by the “ReportConfig”, the “MDT MeasReport” in which the measurement result in the measurement target designated by the “MeasObject” is included.

In step S1008, the radio base station eNB transmits to the mobile station UE, by using the SRB1, “RRCConnectionReconfiguration (MDT MeasConfig)”, which instructs a change in the configuration of the SRB3.

In step S1009, the mobile station UE transmits to the radio base station eNB, by using the SRB3, “RRCConnectionReconfigurationComplete”.

In steps S1010 and S1011, when the condition designated by the “ReportConfig” is satisfied, the mobile station UE transmits, by using the SRB3 designated by the “ReportConfig”, the “MDT MeasReport” in which the measurement result in the measurement target designated by the “MeasObject” is included.

In accordance with the mobile communication system according to the present embodiment, the mobile station UE is configured to transmit the “MDT MeasReport” by using the SRB designated by the “ReportConfig”, so that it is possible to perform the MDT without wasting a radio resource in the SRB1 and the SRB2.

The characteristics of the present embodiment as described above may be expressed as follows.

A first characteristic of the present embodiment is summarized in that a mobile communication method includes: a step A of transmitting to a mobile station UE, by a radio base station eNB, “MDT MeasConfig (test-use measurement control information)” including “MeasObject (measurement target information)” and “ReportConfig (a reporting condition)” to a mobile station UE; and a step B of transmitting to the radio base station eNB, by the mobile station UE, by using SRB (a signaling-use radio bearer) designated by the “ReportConfig”, “MDT MeasReport (a test-use measurement report)” in which a measurement result in a measurement target designated by the “MeasObject” is included.

In the first characteristic of the present embodiment, the SRB includes SRB1 (a radio bearer for first signaling) for transmitting/receiving RRC signaling, SRB2 (a radio bearer for second signaling) for transmitting/receiving NAS signaling, and SRB3 (a radio bearer for third signaling), and the mobile communication method may include a step of setting up, by using the SRB1, the SRB3 between the radio base station eNB and the mobile station UE.

In the first characteristic of the present embodiment, in the step A, the radio base station eNB may transmit the “MDT MeasConfig to the mobile station UE, by using the SRB3.

A second characteristic of the present embodiment is summarized in that a mobile station UE includes: a reception unit (SRB1 function 24A/SRB3 function 24C) configured to receive “MDT MeasConfig” in which “MeasObject” and “ReportConfig” are included from a radio base station eNB; and a transmission unit (SRB1 function 24A/SRB3 function 24C) configured to transmit to the radio base station eNB, by using SRB (SRB1/SRB3) designated by the “ReportConfig”, “MDT MeasReport” in which a measurement result in a measurement target designated by the “MeasObject” is included.

In the second characteristic of the present embodiment, the SRB includes SRB1 for transmitting/receiving RRC signaling, SRB2 for transmitting/receiving NAS signaling, and SRB3, and the mobile station UE may include a set-up unit (the SRB1 function 24A) configured to set up, by using the SRB1, the SRB3 between the mobile station UE and the radio base station eNB.

A third characteristic of the present embodiment is summarized in that a radio base station eNB includes; a transmission unit (SRB1 function 13A/SRB3 function 13C) configured to transmit “MDT MeasConfig” including “MeasObject” and “ReportConfig to a mobile station UE; and a reception unit (SRB1 function 13A/SRB3 function 13C) configured to receive from the mobile station UE, by using SRB designated by the “ReportConfig”, “MDT MeasReport” in which a measurement result in a measurement target designated by the “MeasObject” is included.

In the third characteristic of the present embodiment, the SRB includes SRB1 for transmitting/receiving RRC signaling, SRB2 for transmitting/receiving NAS signaling, and SRB3, and the radio base station eNB may include a set-up unit (the SRB1 function 13A) configured to set up, by using the SRB1, the SRB3 between the radio base station eNB and the mobile station UE.

In the third characteristic of the present embodiment, the transmission unit (the SRB3 function 13C) may be configured to transmit the “MDT MeasConfig” to the mobile station UE, by using the SRB3.

In the first to third characteristics of the present embodiment, the priority (QCI) of the SRB3 may be lower than the priority of the SRB1 and the priority of the SRB2.

Note that the operation of the mobile station UE or the radio base station eNB may be performed by hardware, a software module performed by a processor, or a combination of the both.

The software module may be arranged in a storage medium of an arbitrary format such as a RAM (Random Access Memory), a flash memory, a ROM (Read Only Memory), an EPROM (Erasable Programmable ROM), an EEPROM (Electronically Erasable and Programmable ROM), a register, a hard disk, a removable disk, or a CD-ROM.

The storage medium is connected to the processor so that the processor can write and read information into and from the storage medium. Such a storage medium may also be accumulated in the processor. Such a storage medium and processor may be arranged in an ASIC. The ASIC may be arranged in the mobile station UE or the radio base station eNB. Furthermore, such a storage medium and processor may be arranged in the mobile station UE or the radio base station eNB as discrete components.

Thus, the present invention has been explained in detail by using the above-described embodiments; however, it is obvious that for persons skilled in the art, the present invention is not limited to the embodiments explained herein. The present invention can be implemented as a corrected and modified mode without departing the gist and the scope of the present invention defined by the claims. Therefore, the description of the specification is intended for explaining the example only and does not impose any limited meaning to the present invention.

### INDUSTRIAL APPLICABILITY

As described above, according to the present invention, it is possible to provide a mobile communication method, a mobile station, and a radio base station, by which it is possible to perform MDT without wasting a radio resource in SRB1 and SRB2.

### REFERENCE SIGNS LIST

eNB . . . Radio base station
UE . . . Mobile station
11 . . . S1-AP/X2-AP function
12 . . . RRC function
13A, 24A . . . SRB1 function
13B, 24B . . . SRB2 function
13C, 24C . . . SRB3 function
13D1,24D1 . . . DRB1 function
13D2,24D2 . . . DRB2 function
13Dn,24Dn . . . DRBn function
14A to 14F, 25A to 25F . . . PDCP/RLC function
15, 26 . . . Scheduler/Multiplexing function
16A to 16C, 27A to 27C . . . HARQ function
17, 28 . . . PHY function
21 . . . NAS function
22 . . . RRC function
23 . . . Application function

1. A mobile communication method comprising:
a step A of transmitting to a mobile station, by a radio base station, measurement control information including a Minimization of Drive Tests (MDT)-use reporting condition, by using a first signaling-use radio bearer; and
a step B of transmitting to the radio base station, by the mobile station, by using a second signaling-use radio bearer, on the basis of the MDT-use reporting condition, an MDT-use measurement report including a measurement result in a measurement target, wherein
the first signaling-use radio bearer is a signaling-use radio bearer having a higher priority than the second signaling-use radio bearer.

2. A mobile station comprising:
a reception unit configured to receive, from a radio base station, measurement control information including a Minimization of Drive Tests (MDT)-use reporting condition, by using a first signaling-use radio bearer; and
a transmission unit configured to transmit, to the radio base station, by using a second signaling-use radio bearer, on the basis of the MDT-use reporting condition, an MDT-use measurement report including a measurement result in a measurement target, wherein
the first signaling-use radio bearer is a signaling-use radio bearer having a higher priority than the second signaling-use radio bearer.

3. A radio base station comprising:
a transmission unit configured to transmit to a mobile station, measurement control information including a Minimization of Drive Tests (MDT)-use reporting condition, by using a first signaling-use radio bearer; and
a reception unit configured to receive, from the mobile radio base station, by using a second signaling-use radio bearer, the MDT-use measurement report including a measurement result in a measurement target, said measurement result being transmitted on the basis of the MDT-use reporting condition, wherein
the first signaling-use radio bearer is a signaling-use radio bearer having a higher priority than the second signaling-use radio bearer.
